(19) United States
(12) Patent Application Publication
(10) Pub. No.: US 2018/0124319 A1
(43) Pub. Date: May 3, 2018

(54) METHOD AND APPARATUS FOR REAL-TIME TRAFFIC INFORMATION PROVISION

(71) Applicant: SAMSUNG SDS CO., LTD., Seoul (KR)

(72) Inventor: Seong Ho JO, Seoul (KR)

(73) Assignee: SAMSUNG SDS CO., LTD., Seoul (KR)

(21) Appl. No.: 15/795,902

(22) Filed: Oct. 27, 2017

(30) Foreign Application Priority Data
Oct. 28, 2016 (KR) 10-2016-0142416

(51) Int. Cl. H04N 5/232; H04N 5/14; G08G 1/01; G06T 7/285; G06T 7/254; G06K 9/00

(52) U.S. Cl. CPC H04N 5/23254; H04N 5/145; G08G 1/0104; G06K 9/00771; G08G 1/0141; G06T 7/285; G06T 7/254; G08G 1/0116

(57) ABSTRACT

A method for recognizing a moving object includes receiving real-time video data from an image capturing device by an object recognition apparatus, extracting a first image at a first time point of the real-time video data by the object recognition apparatus, extracting a first background image from the first image, extracting a second image at a second time point of the real-time video data by the object recognition apparatus, wherein the second time point is after the first time point, updating the first background image to a second background image based on the second image, comparing the second image with the second background image to extract a moving object, and extracting the moving object.

This application claims priority from Korean Patent Application No. 10-2016-0142416 filed on Oct. 28, 2016 in the Korean Intellectual Property Office, the disclosure of which is incorporated herein by reference in its entirety.

### BACKGROUND OF THE INVENTION

### 1. Field of the Invention

The present invention relates to a method and an apparatus for providing real-time traffic information. More specifically, the present invention relates to a method for collecting traffic information by analyzing video collected via a CCTV or the like, and providing real-time traffic information and traveling information to drivers on the basis of the collected traffic information, and an apparatus for performing the method.

### 2. Description of the Related Art

Human beings have become able to live a more convenient life due to spread of transportation means according to industrial revolution. Along with the spread of the transportation means, research on a method for efficiently utilizing the spread transportation method also became important. Problems occurring in the driver due to traffic congestion, absence of map information, etc. may also be problems discussed on the same line as the method for efficiently utilizing transportation means.

Early navigation has only the function of providing map information and route information not reflecting real-time road information to the driver. Recently, with the development of IT communication technique, the navigation also has its own network communication means. Accordingly, the navigation has also been developed to be able to receive various kinds of information from a traffic information management server and to provide real-time information to drivers, using the information. However, conventional some techniques for collecting and providing traffic information have problems such as a large cost for constructing an infrastructure, or a failure to efficiently present the real-time road conditions due to an occurrence of delay occurs. In order to aid understanding, prior to the description of the present invention, a brief description will be given of a method for providing traffic information which has been conventionally presented. Conventionally, several methods for collecting and providing traffic information for smooth running of the driver have also been proposed.

As the most representative method for providing traffic information, TPEG (Transport Protocol Expert Group) may be used. TPEG is a flat form that transmits traffic information to user terminals such as navigation, using the DMB frequency. TPEG has an advantage capable of using the spread DMB broadcasting infrastructure, but the following problems exist.

Since TPEG is only a traffic broadcasting service rather than a traffic information technique, it can be applied only when the DMB broadcasting is permitted, and it is indispensably necessary to utilize a sensor and observe the naked eye for gathering information. As a result, in general, a delay of about 15 to 30 minutes occurs, and the delay may be fatal in a traffic information providing service that changes in real time. TPEG solves the above problems and additionally utilizes other traffic prediction methods to improve the performance. Further, there is also a drawback that large funds are required to construct the TPEG infrastructure, and there is also a problem that it is not possible to export TPEG to underdeveloped countries in which infrastructure development is inadequate.

As another traffic information collection technique, a sensor-based collection technique is also proposed. The sensor-based collection technique is a technique for collecting the amount of passing vehicles, by a sensor installed on the road ground of several sections to detects loads of vehicles passing through installed region and generate electromagnetic waves, or by laser/optical sensors installed on roadside. In the case of the sensor-based collection technique, there is an advantage that accuracy is high in terms of sensing at a position in close contact with the vehicle, but the following problems exist.

In order to use the sensor-based collection technique, since it is necessary to install a sensor on the road ground, it can be applied only to some sections in which the sensors are installed, and it is necessary to individually install a power generator, a GPS or the like at an intersection etc. where sensors are installed so that the measurement information can be provided to the server. That is, the sensor-based collection technique has a problem that the cost required for constructing sensors and infrastructure is very high.

Also, as another traffic information gathering technique, a video-based collection technique is presented. In the video-based collection technique, a device with relatively low load such as a camera provides image information to the server, and the server analyzes the images to analyze the traffic flow. Since the video-based collection technique requires only cameras and computing devices for image analysis, there is an advantage that infrastructure construction is simple, but there are following problems.

In the video-based collection technique, the traffic information providing server receives video or image obtained by capturing roads via a camera. The traffic information providing server analyzes the received image and grasps the presence or absence, movement, etc. of the object existing on the road. In order to analyze the image by the traffic information providing server with the conventional video-based collection technique, all kinds of objects that may exist on the road need to be stored in a database in advance.

When an undefined object is detected, the traffic information providing server may omit the object and may not provide accurate traffic information. Because the kind of objects needed to be defined here include all the car type or the like of automobile as well as automobile, people, and terrain, in order to make use of video-based collecting technique, it is necessary to use devices with high computing power.

Further, since an analysis is performed on the basis of an image, in the case where too many objects are concentrated on the image which makes it difficult to separate the different two objects, the accuracy is greatly reduced. Due to a problem occurring due to such concentration, there is a problem of difficulty in separation due to the overlapping phenomenon between objects even if the resolution of the image is sufficiently high, and as the resolution of the screen decreases, more problems occur, and eventually, there are limits that cannot be solved. The video-based collection technique generally uses a CCTV and the like, but in the case of CCTV installed in the past, in most cases, the resolution is not high. Accordingly, there is a problem that image analysis using these devices may not derive accurate results.

Therefore, there is a need for a method capable of more efficiently collecting traffic information and providing the traffic information and traveling information reflecting real-time road conditions to the driver.

### SUMMARY OF THE INVENTION

An aspect of the present invention provides a method for collecting traffic situation information in real time, using an image capturing device such as a CCTV, and an apparatus for executing the method. Thus, the traffic information providing apparatus can efficiently collect real-time information, such as an automobile, a pedestrian, a sudden situation, and the like present on the road.

Another aspect of the present invention provides a method for extracting a background image, by deep-learning analysis of videos collected through an image capturing device such as a CCTV, and an apparatus for executing the method. Therefore, the traffic information providing apparatus can more reliably separate the background and the vehicle on the road, and can update the background image in real time.

Still another aspect of the present invention provides a method which extracts objects from an image collected through an image capturing device such as a CCTV and performs clustering on the extracted objects in accordance with the movement direction, velocity and the like, and then analyzes the traffic flow, using the movement of clustering, and an apparatus for executing the method. Accordingly, since the traffic information providing apparatus does not need to define each object on the image, it is possible to reduce an amount of data computation.

Still another aspect of the present invention provides a method for efficiently analyzing the traffic flow, using real-time traffic information collected via an image capturing device such as a CCT, and an apparatus for executing the method. Therefore, the driver can receive provision of the optimum route and the real-time bypass information reflecting the real-time traffic information, the advance prediction information of the traffic congestion.

The aspects of the present invention are not limited to those mentioned above but another aspect which has not been mentioned will be clearly understood from the description below to the ordinary technician in the technical field of the present invention.

In some embodiments, a method for recognizing a moving object, the method comprising: receiving real-time video data from an image capturing device by an object recognition apparatus; extracting an image at a first time point of the real-time video data by the object recognition apparatus; extracting a first background image from the first image; extracting a second image which is an image at a second time point after the first time point of the real-time video data, by the object recognition apparatus; updating the first background image to a second background image with reference to the second image, and comparing the second image with the second background image to extract a moving object.

The effects of the embodiment of the present invention are as follows.

When using the present invention as described above, there is an effect of being able to collect real-time traffic information, using an image capturing device such as a CCTV provided on an existing road or the like, without constructing an infrastructure requiring high cost. Since the road analysis using a simple image capturing device is allowed, there is an effect of being able to collect the traffic information when a CCTV or the like is installed even on a road of small scale.

When using the present invention as described above, there is an effect in which a background image is extracted from the image using the deep-learning technique, even without a high-performance computing device, and the objects on the load can be identified using the extracted background. Since the background image is updated in real time in accordance with the deep-learning technique, there is an effect that the object can be identified by more effectively reflecting the real-time situation, as compared with the existing video analysis-based traffic information analysis technique.

When using the present invention as described above, since it is not necessary to define each object detected on the image, there is an effect of being able to reduce the amount of data computation required for the image analysis, thereby reducing load of the traffic information providing apparatus. Since errors due to object-specific definitions do not occur, there is an effect of being able to reduce degradation in accuracy occurring at the stage of object definition of existing image analysis.

When using the present invention as described above, since it is possible to predict the traffic volume of specific coordinates on the map in advance, and the delay for analyzing the traffic situation and providing information is minimized, there is an effect of being able to provide the driver with the optimum running information and the real-time bypass information in which the advance prediction information is reflected.

The effects of the present invention are not limited to the effects mentioned above, and another effect not mentioned can be clearly understood by ordinary technicians from the following description.

### BRIEF DESCRIPTION OF THE DRAWINGS

The above and other aspects and features of the present invention will become more apparent by describing in detail exemplary embodiments thereof with reference to the attached drawings, in which:

FIG. 1 is a schematic diagram for explaining a real-time traffic information providing system according to some embodiments of the present invention;

FIG. 2 is a flowchart illustrating a method for providing real-time traffic information according to an embodiment of the present invention;

FIG. 3 is a flowchart for explaining a method for the traffic information providing apparatus to identify an object according to an embodiment of the present invention;

FIGS. 4 to 5 are diagrams for explaining the image co-registration method;

FIG. 6 is another flowchart for explaining the method for the traffic information providing apparatus to identify the object in more detail;

FIG. 7 is a diagram for explaining a method for detecting a change in a video and extracting an object;

FIG. 8 is a flowchart for explaining a method for analyzing a traffic flow in real time by the traffic information providing apparatus;

FIG. 9 is a diagram for explaining a method for extracting a velocity vector from the extracted object by the traffic information providing apparatus;

FIG. 10 is a diagram for explaining a method for clustering the extracted objects by the traffic information providing apparatus;

FIG. 11 is a flowchart illustrating a method for selecting a central object by the traffic information providing apparatus in accordance with an embodiment of the present invention;

FIG. 12 is a diagram for explaining the movement trajectory of the central object;

FIG. 13 is a diagram for explaining a method for computing the density of clusters by the traffic information providing apparatus in accordance with an embodiment of the present invention;

FIG. 14 is a diagram for explaining a method for analyzing the movement of the generated cluster by the traffic information providing apparatus;

FIG. 15 is a flowchart for explaining a method for monitoring the traffic flow in real time by the traffic information providing apparatus;

FIG. 16 is a diagram for explaining a method by which traffic information providing apparatus monitors the traffic flow in real time in accordance with some embodiments of the present invention;

FIG. 17 is a diagram for explaining a method by which the traffic information providing apparatus provides real-time traffic information to the driver in accordance with some embodiments of the present invention;

FIG. 18 is a block diagram for explaining a traffic information providing apparatus according to an embodiment of the present invention; and

FIG. 19 is a hardware configuration diagram for explaining a traffic information providing apparatus according to an embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Various conventional traffic information providing techniques have the aforementioned problems, the invention solving the aforementioned problems of the related art is presented through the present specification.

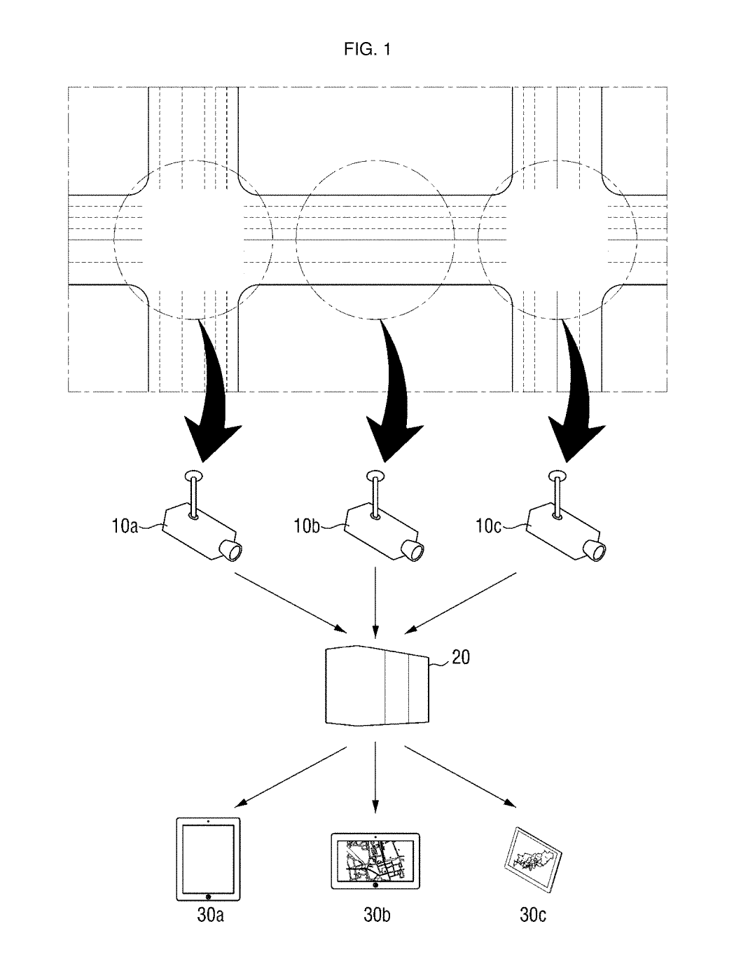

FIG. 1 is a schematic diagram for explaining a real-time traffic information providing system according to some embodiments of the present invention.

A method for providing traffic information according to the present embodiment may be performed by a traffic information providing apparatus 20 wired or wirelessly connected to a plurality of image capturing devices 10a, 10b, and 10c, and a plurality of user devices 30a, 30b, and 30c. In the present invention, the traffic information providing apparatus 20 may be a server that manages data and functions of the plurality of image capturing devices 10a, 10b, and 10c and a plurality of user devices 30a, 30b, and 30c.

The user devices 30a, 30b, and 30c are devices provided by a driver requiring the real-time traffic information, and receive real-time traffic information from the traffic information providing apparatus 20, and provide the traffic information to the driver. The driver may request real-time traffic information and route information required for the traffic information providing apparatus 20 using the user devices 30a, 30b, and 30c, and may provide the current position information.

The image capturing devices 10a, 10b, and 10c preferably mean a CCTV (Closed Circuit Television) located on the road, but various types of camera apparatuses capable of collecting image information may be included therein.

The user devices 30a, 30b, and 30c preferably mean a smart phone or navigation. However, the user devices may include a mobile phone, a laptop computer, a digital broadcasting terminal, a PDA (personal digital assistants), a PMP (portable multimedia player), a slate PC, a tablet PC, an ultrabook, a wearable device (e.g., a smartwatch, a smart glass, and an HMD (head mounted display)), a digital TV, a desktop computer, a digital signage, and the like, and the present invention is not limited thereto.

Although the name of the present invention is presented as a method for providing traffic information, but utilization of the present invention is not limited to collection of traffic information. In other words, the present invention can also be used for flowing population measurement such as mart, amusement park, and water park with many flowing population. The present invention can be implemented when it is necessary to identify a plurality of objects using a camera device and analyze the flow of a plurality of objects.

For example, when utilizing the present invention in an amusement park, the object information providing apparatus according to another embodiment of the present invention may capture an image of a user through a CCTV or the like installed inside an amusement park, and may analyze the collected images to analyze the movement of the users in the amusement park. In this case, the object information providing apparatus may provide the user device of the users with real-time path information for allowing the users of the amusement park to reach the destination, user information on the rides and the like.

In the present specification, the description will be given of a case where the user devices 30a, 30b, and 30c are smartphones or navigations having a navigation function for providing traffic information, and the traffic information providing apparatus is a traffic information providing server that provides real-time traffic information to the driver, as an example. Further, the description will be given of a case where the plurality of image capturing devices 10a, 10b, and 10c is CCTVs installed on the road, as an example. Hereinafter, in order to facilitate understanding, it is noted that the description of the operation subjects of each action included in the above-described method for providing traffic information may be omitted.

In the real-time traffic information providing system according to an embodiment of the present invention, a plurality of image capturing devices 10a, 10b, and 10c capture images of roads and provide them to the traffic information providing apparatus 20. The traffic information providing apparatus 20 separates the videos provided from the plurality of image capturing devices 10a, 10b, and 10c on a frame basis and executes the image analysis.

After identifying an object existing on the road by image analysis, the traffic information providing apparatus 20 can analyze the traffic flow of the zone captured by each image capturing device based on the movement of the identified object. The traffic information providing apparatus 20 may provide optimum route information and real-time traffic flow information to the user terminals 30a, 30b, and 30c in accordance with the analyzed traffic flow.

The term “object” used in the present specification means all types of things exposed to video or image captured by the image capturing device. For example, the object may include a car, a pedestrian, a bicycle, and the like. The object is not limited to the thing in which the movement is seized. For example, when a construction is performed on a road, a space limited in traffic due to road construction may be recognized as an object occupying a road.

A plurality of image capturing devices 10a, 10b, and 10c located on the road may transmit the video obtained by capturing a road in real time and position information of the plurality of image capturing devices 10a, 10b, and 10c to the traffic information providing apparatus 20. The position information may be utilized for generating a traffic map of the road information providing apparatus 20.

A traffic information providing method according to an embodiment of the present invention provides video information to the road information providing apparatus 20, using an existing installed CCTV. Therefore, the traffic information providing method according to the above embodiment has an effect that there is no need to construct another infrastructure. Further, since CCTV is often installed not only in a wide intersection but also in an alley with a low population, there is an effect of being able to collect detailed traffic information as compared with the conventional method for providing traffic information.

According to the method for providing traffic information used in the present invention, since traffic volume is analysed by analyzing the image received from the CCTV in real time, unlike the existing method having a delay of about 15 to 30 minutes, it is possible to provide traffic information in real time without delay.

Since the traffic information providing apparatus 20 determines the optimum route by reflecting the traffic flow, it is possible to predict the traffic situation and provide the driver with the optimum route in real time. Assuming that the optimum route according to the driver's first request is defined as a first route, the traffic information providing apparatus 20 predicts the traffic flow rate after the first request, and may provide the first route reaching the destination and the other second optimum route (bypass route) to the driver.

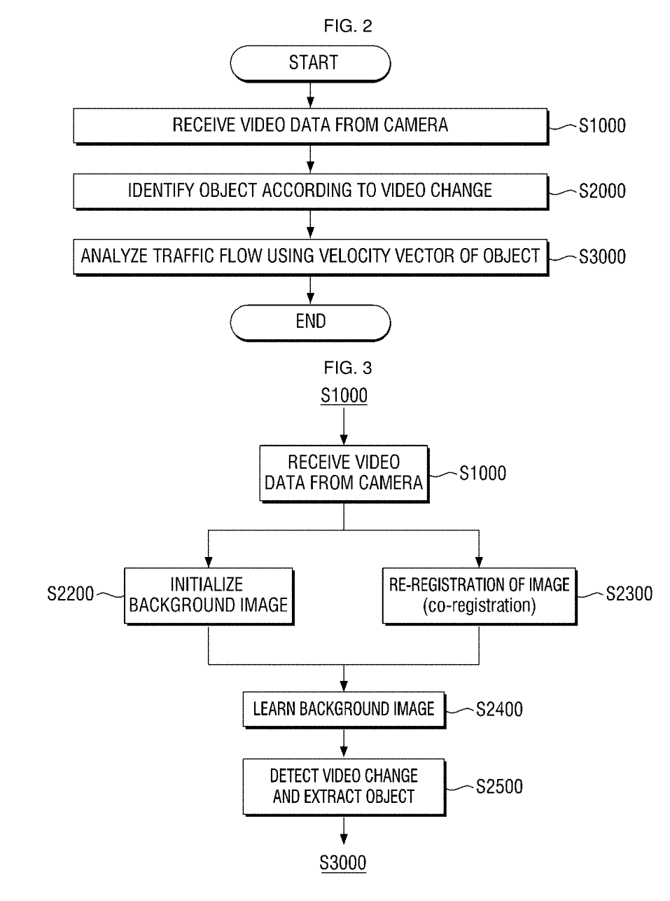

FIG. 2 is a flowchart illustrating a method for providing real-time traffic information according to an embodiment of the present invention.

Referring to FIG. 2, the traffic information providing apparatus 20 receives video data from a plurality of image capturing devices 10a, 10b, and 10c (S1000). Preferably, the traffic information providing apparatus 20 may receive the position information together with the video data. The video data is utilized for setting the background image of the road and analyzing the traffic flow rate.

The traffic information providing apparatus 20 may identify objects existing in the video, using the received video data (S2000). A method for the traffic information providing apparatus 20 to identify the object will be described in more detail with reference to FIGS. 3 to 7. The object may include an automobile, a pedestrian, an accident section, a construction section, and the like.

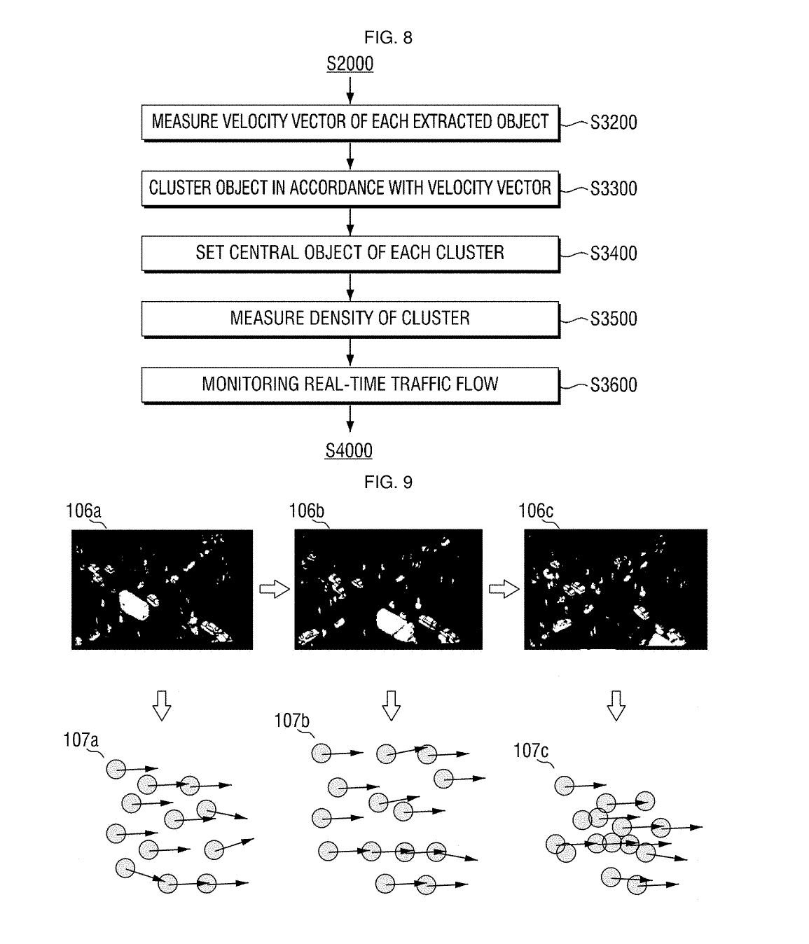

The traffic information providing apparatus 20 analyzes the velocity vectors of the identified objects to analyze the traffic flow, and may provide the analysis result to the driver (S3000). The velocity vector includes velocity information and direction information of the object. Since the traffic information providing method according to the present invention analyzes the traffic flow using video or continuous images, the traffic information providing apparatus 20 may compute the velocity vector of each object. The method for analyzing the flow of real-time traffic by the traffic information providing apparatus 20 will be described in more detail with reference to FIGS. 8 to 14.

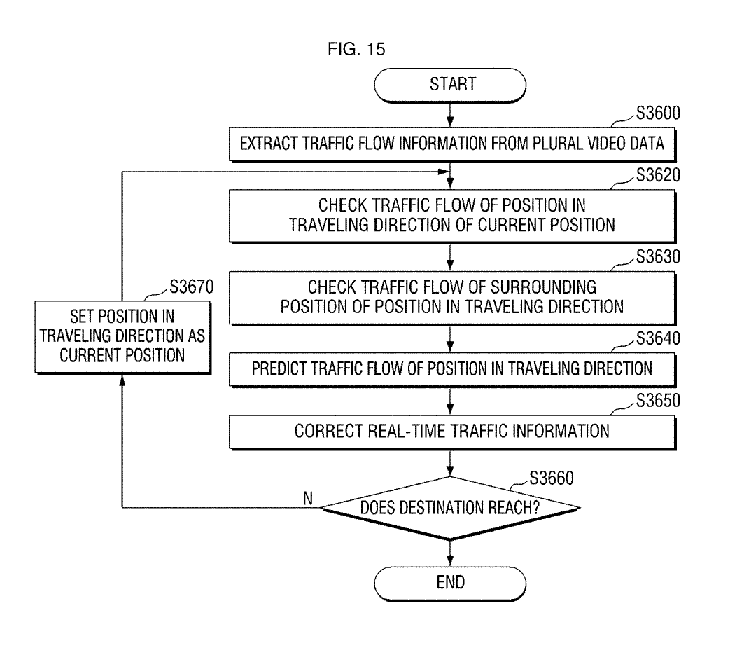

A method for providing real-time traffic information by the traffic information providing apparatus will be described in more detail with reference to FIGS. 15 to 17. The real-time traffic information may include, but is not limited to, map information, real-time traffic information for each section, real-time optimum route information, real-time bypass information and the like.

FIG. 3 is a flowchart for explaining a method for the traffic information providing apparatus 20 to identify an object according to an embodiment of the present invention.

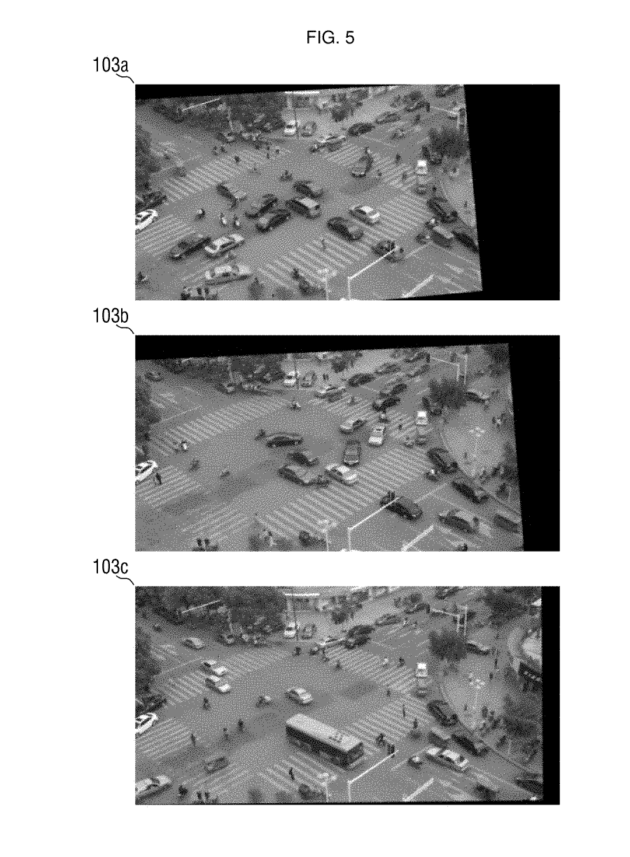

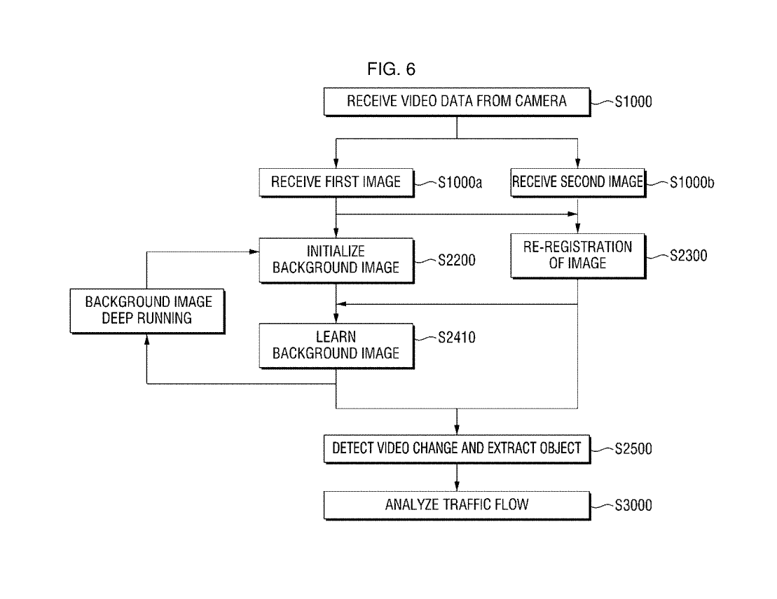

Referring to FIG. 3, the traffic information providing apparatus 20 may perform down-sampling, by dividing the video data provided from a plurality of image capturing devices 10a, 10b, and 10c as a unit of image (S2100). The traffic information providing apparatus 20 may perform co-registration of down-sampled images (S2300). Downsampling and image co-registration will be described in more detail with reference to FIGS. 5 to 6.

The traffic information providing apparatus 20 may initialize a background image utilized for extracting an object from an image separately from image co-registration (S2200). The traffic information providing apparatus 20 compares and analyzes the background image and the newly received image, detects a change in video, and extracts the object.

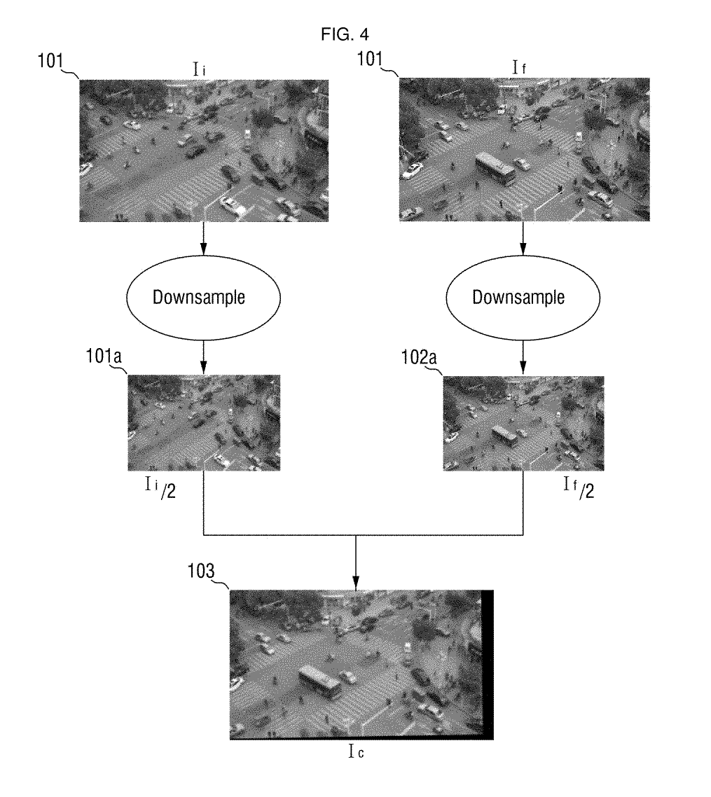

The initialized background image may be learned in accordance with the continuously received image (S2400). For the learning of the background art, the deep-learning algorithm conventionally proposed may be utilized. The initialization of the background image and the learning of the background image will be described in more detail in FIG. 4.

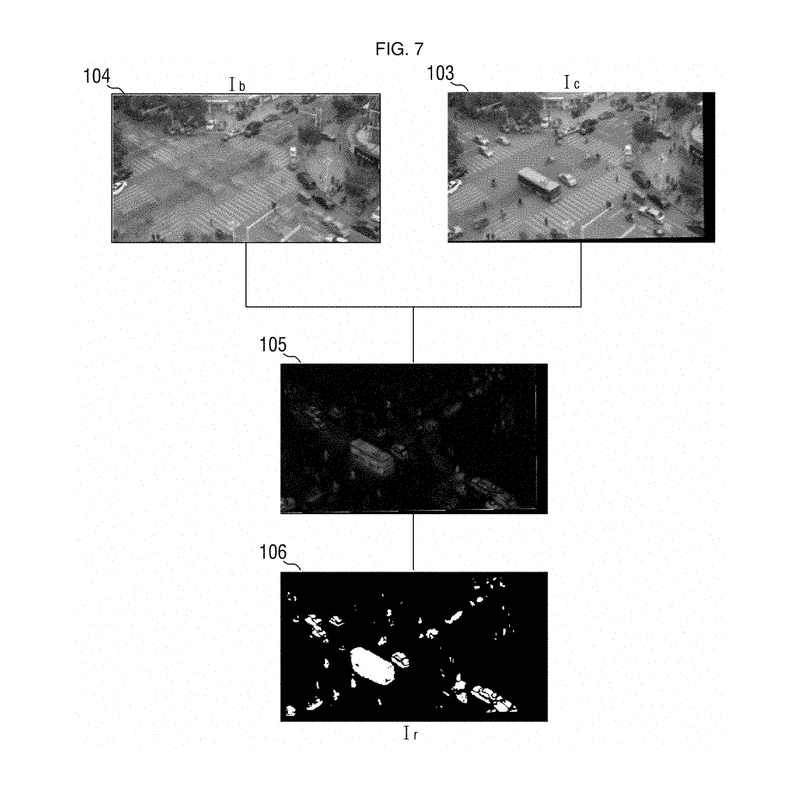

The traffic information providing apparatus 20 may extract the object, using a difference between the background image updated through deep-learning and the newly input image. A method for extracting an object using differences in images will be described in more detail with reference to FIG. 7.

FIGS. 4 to 5 are diagrams for explaining a method for image co-registration according to an embodiment of the present invention.

In CCTV, the image capturing composition is not fixed and is flexible to cover a wider observation range. Since the identification of an object according to the present invention is basically performed by analyzing a difference in images, a process of correcting and aligning changed compositions needs to be accompanied when the composition of the captured video changes.

FIG. 4 illustrates two images 101 and 102 received from one image capturing device located at the same location, but captured at different points of time. The traffic information providing apparatus 20 may receive the first image 101 and the second image 102 from the image capturing device. The traffic information providing apparatus 20 may designate the image initially received after the image observation as the first image 101, and may set it as a reference image I_i for image co-registration. The reference image may also be used for initializing the background image, and this will be described later. The first image is not necessarily limited to the image initially received after the image observation. It is a matter of course that, as long as the image is used for co-registration of the image received thereafter, the image captured at an arbitrary time point may become the reference image.

The traffic information providing apparatus 20 may perform down-sampling of the first image 101 and the second image 102 prior to the image co-registration. In the conventional video-based collection method, since all the identified objects are subjected to the step of defining the object, the resolution of the image used for the analysis needs to be high. However, according to the present invention, as described above, since it is not necessary to define all objects, there is an advantage that the object can also be identified in the relatively low pixels. Therefore, it is preferable that the traffic information providing apparatus 20 performs down-sampling in order to reduce the amount of computation.

In FIG. 4, as an example of down-sampling, results 101a and 101b obtained by setting the resolution to ½ are illustrated. The use of ½ in the down sampling index is an example, and various sampling indices may be utilized to perform the present invention. When the sampling index decreases, there is an effect that the data computation amount of the traffic information providing apparatus 20 decreases, but since there is a risk of a decrease in accuracy in the object recognition, an appropriate sampling index needs to be used.

The traffic information providing apparatus 20 may extract the co-registration image I_c 103 which is the result of co-registration of the second image with reference to the down-sampled first image. The co-registration image 103 is illustrated at the bottom of FIG. 4. Since the co-registration process is performed by partially twisting the angle of the second image, it is possible to check that the co-registration image is partially twisted to the left side compared to the existing second image. It is possible to check that the margin generated by twisting the second image is processed with a space.

FIG. 5 illustrates results 103a, 103b, and 103c obtained by performing co-registration of the images captured at different plural times. When referring to each co-registration image, it is possible to check that the region processed with space differs depending on the change of the composition of the camera.

Originally, since the CCTV is utilized for image capturing a certain area at a wide angle, the image capturing composition generally changes moment by moment. Therefore, when passing through the above-described co-registration step, it is possible to obtain the effect like always capturing a certain region even if the image capturing composition, the image capturing situation, or the like changes. Therefore, there is an effect that it is possible to utilize the traffic information providing method according to the present invention, while maintaining the function of the existing installed CCTV.

FIG. 6 is another flowchart for explaining the method for the traffic information providing apparatus 20 to identify the object in more detail.

Referring to FIG. 6, a method for identifying and recognizing an object is started when the traffic information providing apparatus 20 receives the first image and the second image from the image data (S1000a, S1000b). As explained in the image co-registration method, the first image means an image which can be used for image co-registration and initialization of the background image. The first image may be selected as an image initially received after receiving the video, but the present invention is not limited thereto, as explained above.

The traffic information providing apparatus 20 may perform co-registration of the second image, using the first image (S2300). The process of executing the down-sampling prior to image co-registration by the traffic information providing apparatus 20 may be omitted.

The traffic information providing apparatus 20 may initialize the first image as the background image separately from the image co-registration (S2200). When the first image is set once at the beginning, after receiving the first image, the traffic information providing apparatus 20 continuously receives the second image. The second image means an image at an arbitrary time point extracted for analyzing the traffic situation.

The video-based collection technique proposed in the past also includes logic for selecting a background image, and comparing and analyzing the background image and the newly received image to identify the object. Unlike this, according to the object extraction method according to the embodiment of the present invention, the traffic information providing apparatus may update the background image, using the second image received in real time.

Specifically, a co-registration second image is used to learn the background image. Generally, it is desirable that the background image includes only of roads, excluding street trees, crosswalks, etc. on the image. However, since it is virtually impossible to delete all the objects except the road and receive background data under general circumstances, when permanently keeping the background image set at one time point, errors will occur in traffic information analysis.

For example, when the road is being developed at the time point of capturing the background data and then the road is opened, despite a new road is opened, there is a problem that the traffic information providing apparatus 20 fails to recognize the new road. In order to solve the above problem, a deep-learning method is used.

The following principle is applied to the method for updating the background image according to the present invention. Even though the same scene has been captured many times, if there is a pixel to which the same pixel information is continuously input on the image, there is a high probability that the pixel is a background image. In such a case, the traffic information providing apparatus may set the repeated pixel information as the pixel information of the background image. When such a method is repeatedly applied, because the pixel information that is relatively input is detected in accordance with repetition, the traffic information providing apparatus 20 may obtain more accurate background image.

However, there is also a problem when extracting the background image, using only the above method. For example, when collecting 1,000 pieces of image data for 5 minutes to learn the background image, it is possible to obtain a background image of a fairly accurate level. However, when there is a vehicle stopped on the road for the measured five minutes, the traffic information providing apparatus 20 will recognize the region where the vehicle is stopped as a region that is not a road. As described above, when extracting a background image over a specific period of time, since the background image is limited only for a specific period of time, there is a problem that it is not possible to reflect the road situation changing in real time.

In order to update the background image, the traffic information providing apparatus 20 may separate the region (Road segmentation) determined as a road from the co-registration image. As a method for separating the region determined as a road from the co-registration image by the traffic information providing apparatus 20, a plurality of conventional image analysis methods may be used.

As an example of a method for separating a road from an image, the traffic information providing apparatus 20 may separate the road and the surrounding information from the first image, using the Fuzzy clustering method. Here, the peripheral information means a region in which the pixel information does not change for a certain period of time. The traffic information providing apparatus 20 may initialize the image, from which the region determined as a road as a result of the fuzzy clustering method is extracted, as the background image.

The fuzzy clustering method is a clustering method which presents the possibility that a specific object can belong to a plurality of clusters rather than to only one cluster, and can belong to each cluster, as an example of soft clustering. According to the Fuzzy clustering method, the traffic information providing apparatus 20 may cluster each pixel constituting the image as roads or peripheral information. Detailed method for analyzing images using the fuzzy clustering method may refer to the presented (Non-Patent Literature 0001).

The traffic information providing apparatus 20 may continuously update the background image, using the newly received second image (S2410). Since the traffic information providing apparatus 20 continuously receives video data from the image capturing device, the second image may be input in units of frames of the video. As the cycle of receiving the second image becomes shorter, it is possible to extract a more accurate background image, and it is possible to measure more accurately the traffic flow.

The traffic information providing apparatus 20 may learn the initial background image, using the updated background image (S2420). Various conventional deep-learning methods may be used as a method for learning the initial background image, using the updated background image. The background image deep-learning of the traffic information providing apparatus 20 may be continuously performed in real time, as long as the traffic information providing apparatus 20 is driven.

After receiving the first image for setting the initial background image, only the second image is continuously received. After the background image is initialized, the traffic information providing apparatus 20 may update the current background image in real time, using the second image.

When learning the background image using the real-time update, the aforementioned problems can be solved. When using the real-time update, since the image for referring to the background image is received in real time, the traffic information providing apparatus 20 has an effect capable of obtaining a large amount of reference images for background image learning. As described above, when there are many reference images for extracting the background image, the traffic information providing apparatus 20 may extract a more accurate background image.

The traffic information providing apparatus 20 may detect the change in the background image over a long period of time, as receiving the image in real time. For example, when a road extension work is performed, a construction section should not be accepted as a road during construction period, but the construction section should be recognized after completion of construction. When updating the background image only for the set period of time, it is not possible to detect such a change in the situation. However, when accompanied by real-time updating, the traffic information providing apparatus 20 separates the region as surrounding information during the road construction, and when the road construction is completed, the region may be separated as the road region.

When the frequency of real-time update is appropriately adjusted, the traffic information providing apparatus 20 may also remove the parked vehicle from the background image. In this way, the background image may gradually obtain accurate results by continuous background image deep-learning.

The traffic information providing apparatus 20 may extract the object, by detecting the video change, using the second image matching with the background image acquired through continuous update (S2500). Detection of image change of the traffic information providing apparatus and the object extracting method will be described in more detail with reference to FIG. 7.

FIG. 7 is a diagram for explaining a method for detecting a change in a video and extracting an object.

Referring to FIG. 7, the traffic information providing apparatus 20 may detect a video change, using the second image 103 I_c matching with the updated background image 104 I_b. The traffic information providing apparatus 20 may obtain the video change image 105 through comparison between the information of the pixels of the image 104 matching with the background image 103.

The comparison of the videos may be performed through comparison of the numerical values of the pixel information having the same address value. However, in one embodiment of the present invention, the traffic information providing apparatus 20 may detect changes in images by analyzing patterns of target pixels and nearby pixels. When a change in video is detected simply by comparing pixel information, there is a problem that it is not possible to detect a defect temporarily occurring in the whole video.

For example, when a cloud is temporarily trapped on a road and the road is shaded, if a change in video is detected, using only numerical value comparison for each pixel, since a change in brightness according to the shade is displayed on the whole image, the traffic information providing apparatus 20 determines that a change has occurred in the whole image.

In pixel-by-pixel pattern analysis, after pixel information is represented by a histogram map, it is detected whether a change in pattern of the histogram has occurred near the comparison target pixel. When a change in video is detected by the pattern as described above, even if a situation such as shadow occurs over the entire video, the traffic information providing apparatus 20 may detect this situation.

FIG. 7 illustrates a video change image 105 extracted by comparing the background image 104 with the co-registration image 103 by the traffic information providing apparatus 20. Referring to the video change image 105, it is possible to check that the region in which the video change is not detected is illustrated in black, and the region in which the video change is detected is illustrated in gray.

Since the video change image 105 is obtained through a comparison of the patterns between the pixels, it may be insufficient to immediately use the video change image 105 for analysis of the video change. In order to more accurately separate the object and the background, the traffic information providing apparatus 20 may obtain a final resulting image 106 I_r for detecting the video change by analyzing the video change image 105.

The traffic information providing apparatus 20 compares numerical values between information of adjacent pixels in the video change image 105. When there is a difference in numerical values between adjacent pixels, the traffic information providing apparatus 20 may determine that the video change occurs in the pixel to perform marking on the pixel. The resulting image I_r 106 is obtained by illustrating the marking result. The marking method presented in FIG. 7 is an example of implementing the present invention and does not limit the present invention.

In FIG. 7, the pixel marked with white in the resulting image 106 means that a particular object is placed in that region. Referring to the resulting image 106, it is possible to check that shapes of buses, automobiles, pedestrians, etc. are extracted as objects across the intersection. The traffic information providing apparatus 20 extracts the objects from the resultant image 106, and the extracted objects are used for analysis of traffic flow.

FIG. 8 is a flowchart for explaining a method for analyzing a traffic flow in real time by the traffic information providing apparatus 20.

Referring to FIG. 8, the traffic information providing apparatus 20 may compute the velocity vector of each object from the object information extracted in accordance with the detection of the video change (S3200). Since the traffic information providing apparatus 20 according to the present invention receives the video data in real time, when using the video data that are input at different times, the motion of the object can be represented by the velocity vector.

The traffic information providing apparatus 20 according to the embodiment of the present invention does not need to define all the extracted objects to compute the velocity vector. When the object is extracted in accordance with the object extraction method, the traffic information providing apparatus 20 computes the velocity vector for each object without defining each object with a person, an automobile, or the like. A method for computing the velocity vector of extracted each object by the traffic information providing apparatus 20 will be described in more detail with reference to FIG. 9.

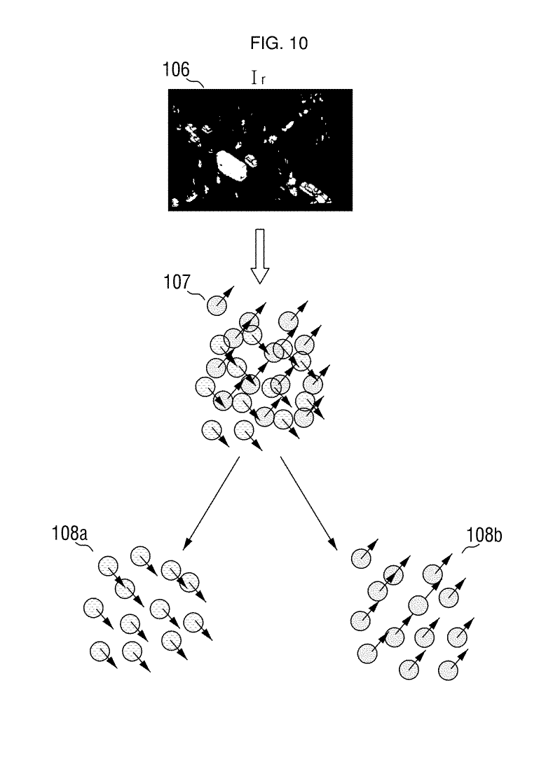

The traffic information providing apparatus 20 may analyze the velocity vectors of the plurality of extracted objects and may cluster the plurality of objects in accordance with the similarity of the velocity vector (S3300). The velocity vector includes speed and direction property as constituent elements. The traffic information providing apparatus 20 clusters the plurality of objects, using the similarities of the speeds of a plurality of velocity vectors and the moving direction. The traffic information providing apparatus 20 does not need to define each object to cluster the extracted plurality of objects. A method for clustering objects by the traffic information providing apparatus 20 will be described in more detail with reference to FIG. 10.

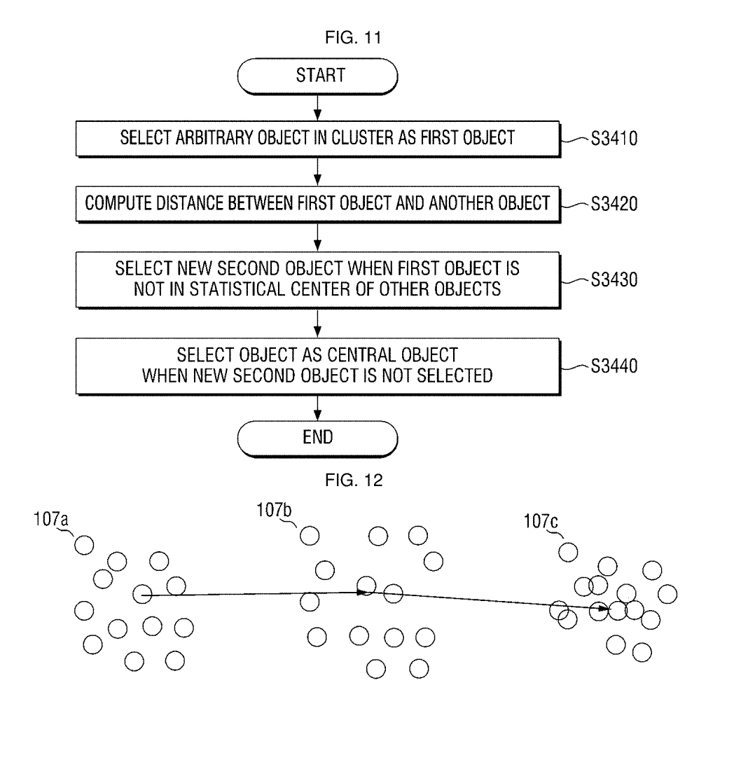

The traffic information providing apparatus 20 may set the central object of each cluster (S3400). The central object is an object used for representing the motion of each cluster, and may be set as any one of a plurality of objects constituting the cluster. The traffic information providing apparatus 20 may analyze the motion of the entire cluster, by analyzing the motion of the central object. A method for setting the central object by the traffic information providing apparatus 20 and analyzing the motion of the entire cluster using the velocity vector of the central object will be described in more detail with reference to FIGS. 11 to 12.

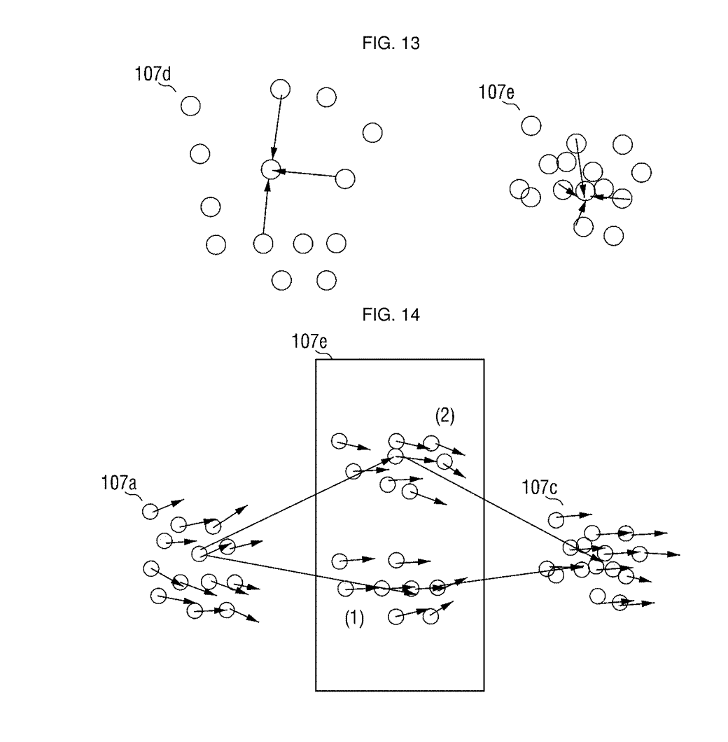

The traffic information providing apparatus 20 may compute the density of each cluster (S3500). The density of the cluster may be used to compute the traffic volume by the traffic information providing apparatus 20. The method for computing the cluster density by the traffic information providing apparatus 20 will be described in more detail with reference to FIG. 13.

The traffic information providing apparatus 20 may analyze the motion of each of the plurality of computed clusters to monitor the real-time traffic flow. The real-time traffic flow monitoring of the traffic information providing apparatus 20 will be described in more detail with reference to FIGS. 15 to 17.

FIG. 9 is a diagram for explaining a method for extracting a velocity vector from the extracted object by the traffic information providing apparatus 20.

Referring to FIG. 9, the traffic information providing apparatus 20 may compute a velocity vector of each extracted object, by analyzing a plurality of resulting images 106a, 106b, and 106c. The traffic information providing apparatus 106 does not need to define each extracted object prior to computing the velocity vector. When an object is extracted to such a degree that each object can be distinguished, the traffic information providing method according to the present invention may be utilized.

Since each object is not defined, the traffic information providing apparatus 20 does not need to have a database for defining all objects. As a result, there is an effect capable of solving an increase in the amount of computation and a drop in identification accuracy generated by defining all objects in the conventional video-based collection technique. For example, when a car, a bus, and a truck of different shapes are running on the road, the traffic information providing apparatus 20 merely classifies the car, the bus, and the track into only “arbitrary objects”, and does not define what things each object means.

The traffic information providing apparatus 20 may compute the velocity vector for each object by analyzing the movement trajectory of all the objects existing on the image. The traffic information providing apparatus 20 may compute the moving distance and the velocity after specifying the position of the object at the first time point and the position of the object at the second time point for an arbitrary object. The traffic information providing apparatus 20 may give a velocity vector to each object, using the computed movement distance and speed.

In the lower end of FIG. 9, the result of computing the velocity vector for each object with reference to the resulting images 106a, 106b, and 106c by the traffic information providing apparatus 20 is illustrated. In this way, the traffic information providing apparatus 20 may apply the velocity vector to the object extracted in real time to monitor the motion of each object, and the motion may be analyzed in real time.

FIG. 10 is a diagram for explaining a method for clustering the extracted objects by the traffic information providing apparatus 20.

The traffic information providing apparatus 20 clusters a plurality of objects extracted from one image. The traffic information providing apparatus 20 may cluster the objects by analyzing the tendency of the velocity vectors of the plurality of objects.

Referring to FIG. 10, the traffic information providing apparatus 20 gives a velocity vector to the object extracted from the resultant image I_r 106, and may cluster a plurality of objects 107 given by the velocity vector by one or more clusters 108a and 108b. FIG. 10 illustrates the results of observing a plurality of objects 107 at one time. When the plurality of objects is not separated, a special tendency may not be detected. However, when the plurality of objects 107 is divided into an object 108a moving in the direction of the right lower end an object 108b moving in the direction of the right upper end, the velocity vector of each group has a constant tendency.

Although the traffic information providing apparatus 20 does not define each object, the traffic information providing apparatus 20 may cluster a plurality of objects and analyze the traffic flow information, using the motion of the group. For the sake of convenience, in the drawings, an example in which the resultant image 107 generates two clusters is illustrated, it is obvious that the present invention is not limited thereto.

For example, the description will be given of a case where the traffic information providing apparatus 20 clusters the motion of the object at the intersection of the crossroads. In this case, the traffic information providing apparatus 20 may generate clusters of very various forms. If the intersection is installed across the east, west, north and south, basically, the traffic information providing apparatus 20 may extract the motions of objects across east-west and north-south to generate a total of four clusters. In this case, each velocity vector will show a tendency of going straight along the roads of the intersection and will have a higher speed value than the pedestrian object walking on the sidewalk.

Further, the traffic information providing apparatus 20 may extract a total of eight clusters by extracting objects that turn left or right at each of the intersections of east, west, north and south. When analyzing the video images over too short time, since objects having a tendency of turning left or turning right may not discover large differences from objects going straight, a designer who provide a traffic information provision way needs to appropriately select the cycle of analyzing the image information.

The traffic information providing apparatus 20 does not cluster only the running automobile objects. The traffic information providing apparatus 20 may also cluster motions of pedestrians, bicycles, and the like. Although the pedestrians and the bicycles may move with the same direction property as the automobile objects, since they are generally slower in velocity than other objects and are not influenced by signals and the like, they are clustered as a cluster different from the automobile objects. When the traffic information providing apparatus 20 is utilized only for analyzing the flow of the road traffic, the traffic information providing apparatus 20 may ignore the cluster clustered by a pedestrian, a bicycle or the like, at the time of traffic flow analysis.

FIG. 11 is a flowchart illustrating a method for selecting a central object by the traffic information providing apparatus 20 according to an embodiment of the present invention.

The traffic information providing apparatus 20 may set the clustered central object of clustered each cluster (S3400). Here, the central object means a representative object of a cluster extracted from an arbitrary cluster by the traffic information providing apparatus 20 in order to analyze the motion of the extracted object in units of clusters. The central object desirably selects an object located at the statistical center of the coordinates of the objects constituting the cluster.

With reference to FIG. 11, the method for selecting the central object by the traffic information providing apparatus 20 will be described in detail. The clustering method and the central object selection method illustrated in FIGS. 10 and 11 are an example for implementing the present invention, and are not described to limit the present invention. The traffic information providing apparatus 20 may generate the cluster, using various clustering methods and cluster analysis methods, and may select the central object. Further, the traffic information providing apparatus 20 may also generate a virtual object at a statistical center or the like and may select the virtual object as a central object.

According to FIG. 11, the traffic information providing apparatus 20 selects an arbitrary object in an arbitrary cluster as a first object (S3410). The traffic information providing apparatus 20 may compute the distance between the first object and all other objects in the cluster (S3420). Here, the distance computation may use an Euclidean distance computation method. The traffic information providing apparatus 20 determines whether or not the first object is at the statistical center of the cluster, as a result of distance computation. As a result of the determination, if the first object is not in the statistical center, the traffic information providing apparatus 20 determines that the first object is not a statistical center and may select another second object in the cluster except the first object as the first object (S3430). The traffic information providing apparatus 20 may repeat the selection of the first object to select the central object. When the newly selected object stands at the statistical center, the traffic information providing apparatus stops the selection of the new first object. If the new first object is not selected, the traffic information providing apparatus 20 selects the currently set first object as the central object, and utilizes the central object and the cluster including the central object for the traffic information analysis (S3440).

FIG. 12 is a diagram for explaining the movement trajectory of the central object.

In some embodiments of the present invention, the traffic information providing apparatus 20 basically analyzes the traffic flow, using the motion of clusters, which is a group of objects. FIG. 12 illustrates results 107a, 107b, and 107c obtained by analyzing motions of arbitrary clusters at three different time points. Referring to the respective results, it is possible to know that one of the objects constituting the cluster is selected as the central object. A result of analysis of each object reveals that, although the motion of each object changes little by little, most of the objects show the same motion as the central objects.

The traffic flow that occurs on the actual road will be described as an example. Since all the vehicles going straight on the road move in the same direction, the tendency of the velocity vector appears in the same manner. However, since the actual running vehicle also acts such as changing the lane, the velocity vector of the object may be expressed somewhat differently from the central object. Since the traffic information providing apparatus 20 analyzes the traffic flow using the motion of the group, even when some exceptions occur as described above, the traffic information providing apparatus 20 still may analyze the motion of the whole cluster using the central object, and a large error does not occur accordingly.

As described above, since the traffic information providing apparatus 20 analyzes the traffic flow, using the cluster and the central object, which type of vehicle the respective object is does not become an interest of the traffic information providing apparatus 20, and the data computation amount of the traffic information providing apparatus 20 is largely reduced accordingly.

FIG. 13 is a diagram for explaining a method for computing the density of clusters by the traffic information providing apparatus 20 according to one embodiment of the present invention.

The traffic information providing apparatus 20 may calculate the cluster density using the number of objects in the cluster (S3500). The density may be utilized as a measure for how much traffic volume exists in the region in which the cluster exists.

The traffic information providing apparatus 20 may calculate the cluster density, using the number of objects per unit area for an arbitrary cluster.

In addition to calculation of the number of objects per unit area, the traffic information providing apparatus 20 may compensate for the density computation, using a distance computation. The traffic information providing apparatus 20 may calculate the cluster density, using one or more of the number computation and the distance computation of objects per unit area.

The density calculation using the distance computation will be described. The traffic information providing apparatus 20 may calculate the density of the cluster, using an average value of the distances from the central object to other objects in the cluster. The density of the object is a measure of how many objects are included in a specific space. Computation of the sum of distance (or average) of each of the central object and all other objects may be a measure of density computation. If the average distance from the central object to the individual object is large as a result of the distance computation, since each object exists at a relatively long distance from the central object, in this case, the density of the cluster becomes small. Conversely, if the average distance is small, since this case means that all other objects are gathered in the vicinity of the central object, the cluster density increases. At this time, the area occupied by the cluster in the resulting image space may be referred to.

Two clusters with different densities are illustrated in FIG. 13. It is possible to understand that the density of the cluster 107d illustrated on the left side is relatively larger than the density of the cluster 107e illustrated on the right side. When comparing the distance vector from the central object to other objects, it is possible to check that the average size of the position vector of the cluster 107d illustrated on the left is averagely larger than the cluster 107e illustrated on the right side.

FIG. 14 is a diagram for explaining a method for analyzing the motion of the generated cluster in advance by the traffic information providing apparatus 20.

As described above, the traffic information providing apparatus 20 analyzes the traffic flow on the basis of the motion of the central object. The traffic information providing apparatus 20 may compute the velocity vector of the central object to analyze the traffic flow.

In the case of measuring the traffic flow using only the velocity vector of the central object, as described above, there is an effect that it is possible to effectively analyze the overall traffic flow of the region. However, if a calculation is performed using only the central object, there is a problem in that the separation of the cluster is difficult in the objects clustered as a single cluster once, if there is a situation in which the objects in the cluster need to be separated into different clusters.

The description will be given of a case where a camera captures a point at which the approaching vehicles are divided into two parts on a straight road such as an expressway. Since the vehicle group running straight on one road, the traffic information providing apparatus 20 clusters most vehicles entering the road into one cluster. Since there is a branch point in the traveling direction, the objects of the cluster travel by being separated into two groups in the middle of the road. Even in this case, since both clusters have the similar direction property, the traffic information providing apparatus 20 clusters the group of the two objects into one cluster. In this way, when analyzing the traffic flow using only the central object, it is difficult to deal with a situation in which the clusters should be separated in real time.

In order to solve the above problems, the traffic information providing apparatus 20 may grasp the traffic flow, using the velocity vector of the central object, and may supplement the analysis of the flow of the object, using the velocity vector of each object.

Referring to FIG. 14, it can be seen that the object clustered into one cluster at the first time point 107a is separated into the two clusters 1 and 2 at the second time point 107e. In some cases, the objects may be clustered again into one cluster. It can be seen that the clusters separated into two parts are clustered into one cluster again at the third time point 107c.

As described above, the traffic information providing apparatus 20 analyzes the velocity vector of the central object and updates the cluster in real time, using the velocity vector of each object, when the clusters are separated and are needed to be re-clustered due to a special situation on the road, there is an effect that this situation can be effectively reflected. The traffic information providing apparatus 20 may re-cluster the objects clustered into one cluster in real time, and may re-cluster the clusters, which were originally clustered into different clusters, into one cluster.

FIG. 15 is a flowchart for explaining a method for monitoring traffic flow in real time by the traffic information providing apparatus 20.

For the sake of convenience, a method in which the traffic information providing apparatus 20 receives the video data from a single image capturing device and analyzes traffic flow information from the single image data has been described above. Referring to FIG. 15, a specific method for providing the traffic information in real time by referring to a plurality of video data by the traffic information providing apparatus 20 will be described.

In some embodiments of the present invention, the traffic information providing apparatus 20 receives a plurality of video data received from a plurality of image capturing devices and may analyze the traffic flow information from the plurality of video data (S3610). Since the method for analyzing the traffic flow from each video data by the traffic information providing apparatus 20 is the same as previously described, it will be omitted.

The plurality of pieces of image data may include position information of a space in which the image capturing device capturing the image data is installed. The traffic information providing apparatus 20 may generate a traffic information map, using the position information, and by setting a position at which image data is received as a branch point. The traffic information providing apparatus 20 may cooperatively predict the traffic flow for each position, by referring to the position information on the plurality of image capturing devices. The traffic information providing apparatus 20 may express the traffic information map in the form of a matrix.

The traffic information providing apparatus 20 may transmit the traffic information map attached with the real-time traffic information to the driver. The traffic information map reflecting the real-time traffic information may be visually provided to a driver via the user device 30.

The driver may request the traffic information providing apparatus 20 for the optimum route for going to the destination or the traffic information on the interest region. Hereinafter, a method for setting a real-time optimum route in response to a request of the driver by the traffic information providing apparatus 20 and a method for predicting the traffic flow in the interest region will be specifically described.

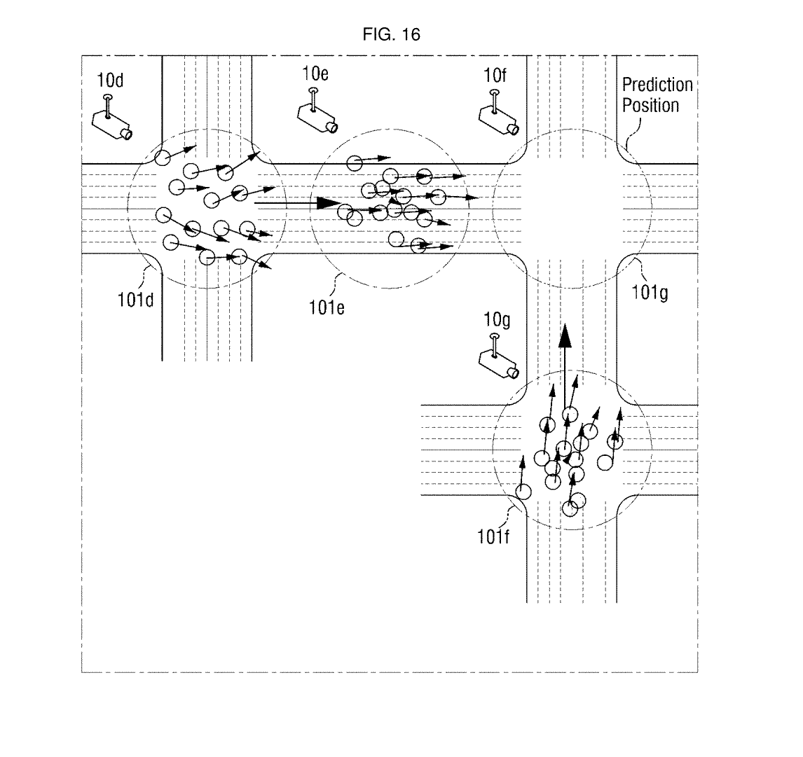

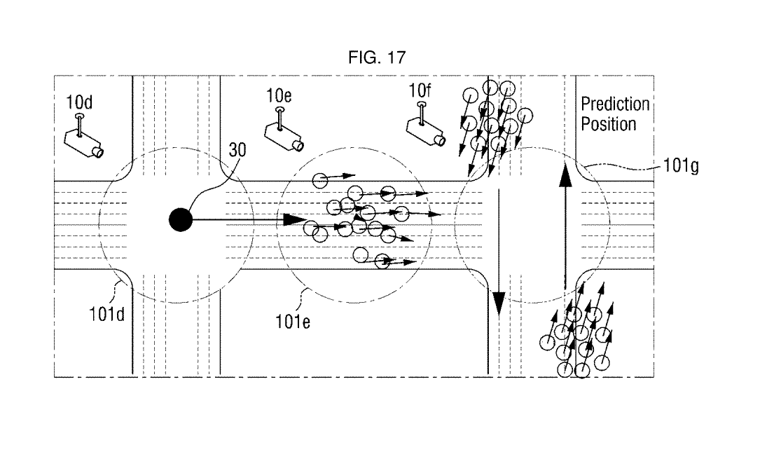

FIG. 16 is a diagram for explaining a method for monitoring traffic flow in real time according to some embodiments of the present invention, and FIG. 17 is a diagram for explaining a method for providing the real-time traffic traveling information to a driver by the traffic information providing apparatus according to some embodiments of the present invention.

With reference to FIGS. 15 to 17, a method for providing the real-time optimum route information by the traffic information providing apparatus 20 when the driver requests the optimum route will be described. The traffic information providing apparatus 20 may analyze the traffic conditions for each section on the basis of the current road information, and then may visually provide the optimum traveling information to the user device 30 of the driver.

According to the method for providing traffic information of the present invention, it is possible to provide the optimal travel information to the driver, using the prior prediction of the traffic flow in a specific section as well as the current road condition. The conventional optimum traveling information provision method analyzes the traffic volume of intersections and the like at the present time, and after calculating the velocity and running time for each section, selects and uses them for setting the optimum route determination. Thus, when the driver actually moves to the position, there is a general situation different from the situation provided beforehand. Also, since the traffic volume at the present time was also provided at a delay of about 15 minutes to 30 minutes, there was a problem that it was difficult to reflect the flow in real time.

In the present invention, in order to solve the above problem, a method for predicting a traffic volume at that position in consideration of the time at which the user reaches the position is utilized. Since traffic flow information provided from the real-time image capturing device is reflected, the traffic volume is predicted and the predicted results are provided to the driver, there is an effect capable of solving the above-mentioned problems.

FIG. 16 illustrates an example in which the traffic information providing apparatus 20 receives the video data of a plurality of regions 101d, 101e, 101f, and 101g from a plurality of image capturing devices 10d, 10e, 10f, and 10g on an arbitrary map. The traffic information providing apparatus 20 may cluster the objects, and may analyze the traffic flow of each section, using the central object of the cluster in accordance with the traffic flow analysis method described above. Since each section is organically connected to each other, when the traffic flow at one position is known, it possible to predict the traffic volume of another position in consideration of the influence of the traffic volume on other areas.

For example, referring to the cluster of the first position 101d, it is possible to know that all the objects of the cluster move to the right side. The traffic information providing apparatus 20 may predict the traffic volume that will reach the second position after a specific time, using the velocity vector and the cluster density of the central object at the current first position 101d. Assume that the traffic information providing apparatus 20 observes that the cluster having the density of “serious” level moves from the first position 101d to the second position 101e at a velocity of 10 km. Assuming that the first position 101e and the second position 101f are separated by about 5 km from each other, as long as there are no special circumstances, the cluster of the current first position 101e will reach the second position 101f after 30 minutes. That is, the traffic information providing apparatus 20 may predict the traffic flow information of the second position 101f after 30 minutes, using the traffic flow information of the current first position 101e. The traffic information providing apparatus 20 may inform the driver that, even if the clusters reach the second position 101f, the current “serious” level traffic volume is maintained, on the basis of the predicted content.

A method for predicting the traffic flow information of a specific position on a straight road by the traffic information providing apparatus 20 has been described above. A method for analyzing the traffic flow by the traffic information providing apparatus 20 at the intersection will be described below.

Assume that the current position of the driver is the aforementioned second position 101f. Assuming that the predicted point 101g of the traffic information providing apparatus 20 is as illustrated, the traffic information providing apparatus 20 may predict the traffic flow information of the predicted point by referring to the traffic flow of the third position 101f organically connected to the predicted point.

Assume that the traffic information providing apparatus 20 observes that a cluster having a density of “normal” level moves toward the predicted point 101g at a velocity of 50 km/h at the second position 101d. Assuming that the second position 101f and the predicted point 101g are separated from each other by 50 km, the object at the current second position 101e reaches the prediction position 101f approximately 1 hour later, unless there are special circumstances.

At the same time, the traffic information providing apparatus 20 additionally analyzes traffic flow information around the predicted point. For the sake of convenience, an example will be described in which the traffic information providing apparatus 20 monitors the traffic flow by referring to the traffic flow of the third position 101f which is one adjacent peripheral position. Assume that the third position 101f and the predicted point are separated by about 5 km, and a cluster having a density of “serious” level progresses toward the predicted point at a velocity of 5 km/h. The traffic information providing apparatus 20 may determine that the cluster started from the third position 101f also arrives at the predicted point 101g when the cluster at the current position reaches the predicted point 101g.

In the situation as described above, when the traffic flow at the current predicted point 101f has a density of “normal” level, according to the conventional method for providing traffic information, the traffic information providing apparatus 20 will determine that the traffic volume is maintained as “ordinary”, while the driver passes through the predicted point 101g via the second position 101e. However, in reality, since the traffic volume of the third position 101f flows into the predicted point 101g, the actual real-time traffic flow will be different from the result observed on the basis of the present. As described above, the traffic information providing apparatus 20 according to the present invention may provide more accurate real-time traffic information to the driver, by reflecting the traffic flow information of the surrounding position to the traffic flow information of the predicted point 101g.

In FIG. 17, the current position 101d of the driver is displayed as the position of the user terminal 30. The traffic information providing apparatus 20 may analyze the traffic volume of the predicted point 101g on the basis of the current driving position 101d and may provide the traffic volume to the driver. Although the traffic flow density of the current predicted point 101g is “comfortable”, if the traffic flow is predicted to reach the “critical” level around the time when the driver reaches the predicted point 101g due to the traffic volume flow at the top and bottom of the future prediction point 101g, the traffic information providing apparatus 20 may recommend the user does not pass through the second position 101e, but takes advantage of the bypasses route at the current position in real time.

According to the present invention, since it is possible to predict the amount of change in the traffic volume at a specific location, there is an advantage that it is possible to provide the driver with the optimum route in real time, and it is possible to consider change variables of various traffic quantity existing on the road. Further, by expanding the analysis, it is possible to predict the traffic volume for the number of various cases for the traveling direction of the driver.

In the present invention, since the traffic flow including the density of the cluster is analyzed, rather than simply analyzing the traffic volume using only the velocity, when a specific section is not blocked but the density is high, there is an effect of being able to present the risk element to the driver.

Also, since identification is performed on all objects on the road, if circumstances such as assembly, construction, traffic accidents and the like occur on the road, it is possible to automatically grasp and present the circumstances to the driver in real time. Furthermore, changes in traffic flow can be predicted in advance by reflecting the factors of the above circumstance element.

Returning to FIG. 15 again, a method will be described in which the traffic information providing apparatus 20 grasps the traffic information in real time and provides real time traveling information to the driver. The traffic information providing apparatus 20 may check the traffic flow at the position in the traveling direction of the current position of the driver (S3620). The position in the traveling direction means a space in which the image capturing device captures an image on the predicted traveling route of the driver. The traffic information providing apparatus 20 may check the traffic flow the surrounding position in the traveling direction (S3630).

By reflecting the traffic flow of the surrounding position of the position in the traveling direction, when the driver reaches the position in the traveling direction, the traffic information providing apparatus 20 may predict the traffic flow at the position in the traveling direction (S3640). The traffic information providing apparatus 20 may correct the real-time traffic information 3650, using the traffic flow in the predicted traveling direction position. When the presentation of a bypass route is requested in accordance with the predicted result as the correction result, the traffic information providing apparatus 20 may recommend the real time bypass information and traveling information to the driver.

When the driver reaches the position in the traveling direction with traveling according to the traffic information correction, the traffic information providing apparatus 20 determines whether or not the driver has reached the destination that is initially input (S3660). As a result of the determination, when the driver reaches the destination, the traffic information providing apparatus 20 stops providing the information. If the driver has not arrived at the destination yet, the traffic information providing apparatus 20 may repeat the above steps, after inputting the position in the traveling direction to the new current position.

The method for providing the traffic information and traveling information to the driver in real time by the traffic information providing apparatus 20 when the driver inputs the destination has been described above. The traffic information providing apparatus 20 according to the present invention is not used only in the case where the driver presents the destination. When the driver sets an interest region, the future traffic volume of the interest region is monitored in accordance with the prediction method and may be provided to the driver.

Further, the traffic information that can be provided to the driver by the traffic information providing apparatus 20 is not limited to the traveling information that is visually presented using the navigation. Various types of information that may be presented through the object analysis such as problems that may occur in the traveling direction, specific traffic flow, signal waiting information, presence or absence of an illegally parked vehicle may, of course, be included in traffic information.

The method according to the embodiment of the present invention described above may be performed by execution of a computer program implemented as computer-readable code. The computer program may be transmitted to a second computing device from a first computing device via a network such as the Internet and may be installed on the second computing device, and the computer program may be used in the second computing device, accordingly. The first computing device and the second computing device include all of a server device, a physical server belonging to a server pool for a cloud service, and a fixed computing device such as a desktop PC.

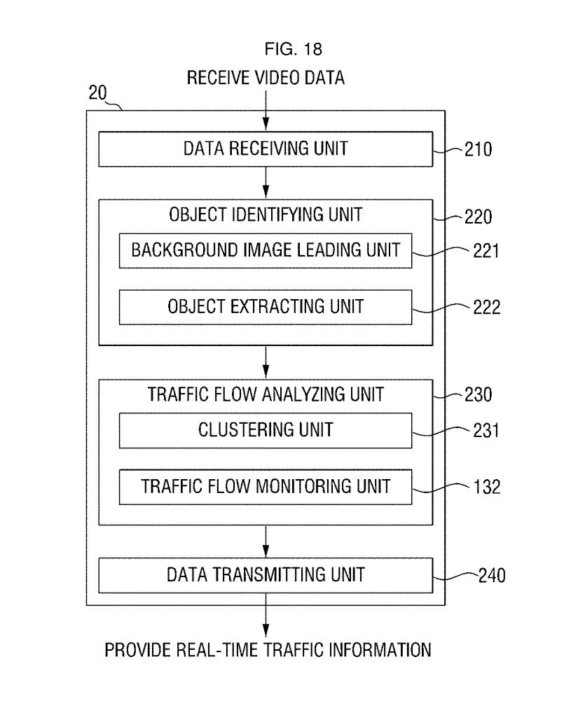

FIG. 18 is a block diagram for explaining a traffic information providing apparatus according to an embodiment of the present invention.

Referring to FIG. 18, the traffic information providing apparatus 20 may include a data receiving unit 210, an object identifying unit 220, a traffic flow analyzing unit 230, and a data transmitting unit 240. Since the operation of each component is the same as that described in the method for providing traffic information, it will be roughly described here.

The data receiving unit 210 receives the video data from the plurality of image capturing devices 10a, 10b, and 10c. The image data may be received in the unit of frame, and position information of the plurality of image capturing devices 10a, 10b, and 10c for creating a traffic information map may be added.

The object identifying unit 220 refers to the image data received by the data receiving unit 210 to identify the object displayed in the video or the image. The object identifying unit 220 may include an image preprocessing unit (not illustrated), an image co-registration unit (not illustrated), a background image learning unit 221, and an object extracting unit 222. The object identifying unit 220 may provide the resulting image I_r, on which the extracted object is displayed, to the traffic flow analyzing unit 230.

The image preprocessing unit may perform preprocessing by dividing the image data input into image units or performing the down-sampling. Since the traffic information providing apparatus 20 according to the present invention does not need to define each identified object, when using the image by down-sampling, it is possible to obtain the effect that the amount of computation is greatly reduced.

The image co-registration unit makes newly input images match the reference image, when there are some mismatching portions of images input at different times due to a change in image capturing situation.

The background image learning unit 221 sets a background image for identifying the object, and may learn the background image by the deep-learning method. Specifically, the background image learning unit 221 initializes the image input at an arbitrary time point as the background image. Thereafter, the background image learning unit 221 may update the current background image by comparing the image of another time point with the initialized background image. The fuzzy clustering method described above may be utilized as the background image learning unit to separate the road and the surrounding information. Since the background image learning method for the background image learning unit 221 is as explained in the moving object recognition method earlier, its explanation is omitted.

The object extracting unit 222 compares the updated background image with the newly input image to extract the object from the image, displays the extracted object on the resulting image I_r, and may provide the result to the traffic flow analyzing unit 230. The object extracting unit 222 may extract the object from the image, by comparing the pixel information of the background image and the resulting image. The object extracting unit may extract an object through a pattern analysis of the determination target pixel and the pixel around the target pixel. Since the object extraction method for the object extracting unit 222 is as explained in the moving object recognition method earlier, its explanation is omitted.

The traffic flow analyzing unit 230 receives the image as a result of displaying the object from the object identifying unit 220, analyzes the velocity vector of the object, and may analyze the traffic flow. The traffic flow analyzing unit 230 may include a velocity vector computation unit (not illustrated), a density computation unit (not illustrated), a clustering unit 231, and a traffic flow monitoring unit 232.

The traffic flow analyzing unit 230 does not need to define each of the object extracted by the object identifying unit. The traffic flow analyzing unit 230 may cluster each cluster without defining each object to analyze the traffic flow in the unit of cluster.

The velocity vector computation unit computes the velocity vector of each object with reference to the resulting image transmitted at the plurality of time points. The clustering unit 231 may analyze the tendency of the velocity vector of the individual objects to cluster the extracted objects into a plurality of clusters. The clustering unit 231 may calculate the center vector of each cluster. The traffic flow analyzing unit analyzes the motion of the entire cluster, using the motion of the center vector. The density computation unit calculates the density of the plurality of clusters. Since the clustering method and the method for selecting the central object are as explained in the method for analyzing traffic flow earlier, the explanation is omitted.

The traffic flow monitoring unit 232 monitors the real-time traffic flow by referring to a plurality of video data. The traffic flow monitoring section 232 may predict the traffic flow of the prediction point existing on the traveling direction on the basis of the current position of the driver. The traffic flow monitoring unit 232 may determine the real-time traveling information and the bypass information to be provided to the driver, on the basis of the real-time traffic flow. Since the traffic flow monitoring method of the monitoring unit 232 has been explained in the real-time traffic flow monitoring method, the explanation is omitted.

The data transmitting unit 240 provides the user terminal 30 with real-time traffic information generated by the traffic flow analyzing unit 230. The real-time traffic information is not limited to traveling information that is visually presented through the navigation. Various types of information that may be presented through the object analysis such as problems that may occur in the traveling direction, specific traffic flow, signal waiting information, and presence or absence of an illegally parked vehicle may, of course, be included in traffic information.

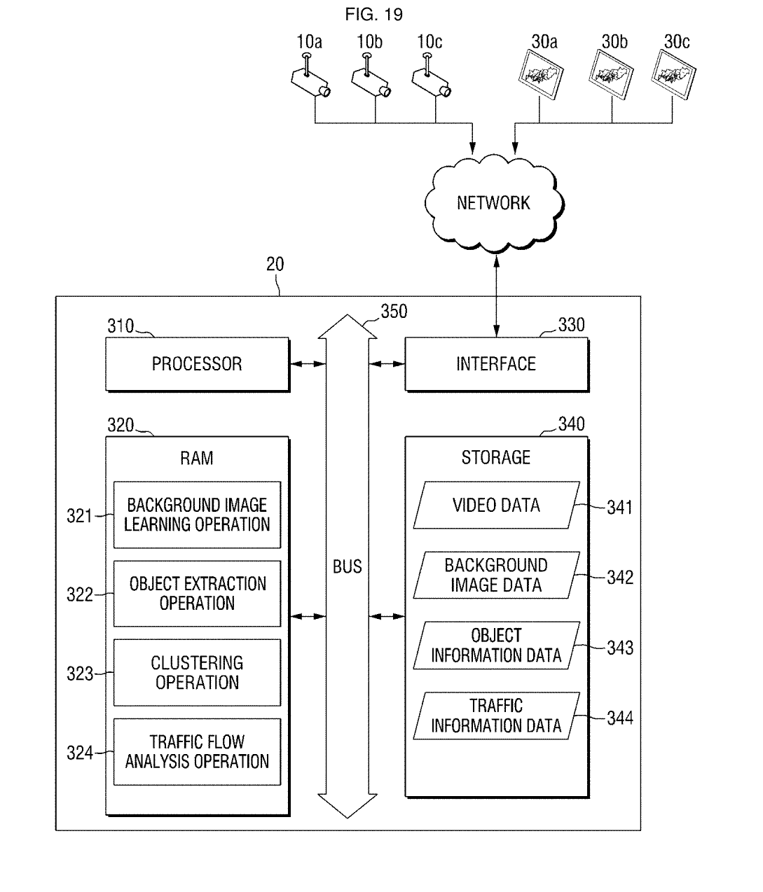

FIG. 19 is a hardware configuration diagram for explaining a traffic information providing apparatus according to an embodiment of the present invention.

Referring to FIG. 19, the traffic information providing apparatus 20 may include one or more processors 310, a memory 320, an interface 330, a storage 340, and a data bus 350.

A traffic information provision operation implemented to execute the method for providing the traffic information may reside in the memory 320.

The memory 320 may include a background image learning operation 621, an object extraction operation 322, a clustering operation 323, and a traffic flow analysis operation 324. Since the detailed action of the operation in the memory 320 is the same as the method for executing each step described in the method for providing traffic information, it will be roughly described here.

The interface 330 may include a network interface for transmitting and receiving information between the plurality of image capturing devices 10a, 10b, and 10c and the plurality of user terminals 30a, 30b, and 30c.

The network interface may transmit and receive data to and from user device in the system, using one or more of a mobile communication network such as a code division multiple access (CDMA), a wide band code division multiple access (WCDMA), a high-speed packet access (HSPA), and a long-term evolution (LTE), or a wired communication network such as Ethernet, a digital subscriber line (xDSL), a hybrid fiber coax (HFC), and an optical subscriber network (FTTH), or wireless local area network such as Wi-Fi, Wibro or Wimax.

A program (not illustrated) implemented to execute the method for providing the traffic information may be stored in the storage 340, and an application programming interface (API) for executing the above program, a library file, a resource file, and the like may be stored in the storage. Further, the storage 340 may store video data 341, background image data 342, object information data 343, traffic information data 44 and the like utilized in the method for providing traffic information.

The data bus 350 is a moving path for transferring data between the constituent elements of the processor 310, the memory 320, the interface 330, and the storage 340.

Each of the constituent elements of FIGS. 2 to 4, 8, 11 and 15 may mean software, or hardware such as FPGA (Field Programmable Gate Array) and ASIC (Application-Specific Integrated Circuit). However, the above-described constituent elements are not limited to software or hardware, may be configured to be located in a storage medium capable of addressing, and may be configured to execute one or more processors. The functions provided in the above-mentioned components may be implemented by further segmented components, and may be implemented as one constituent element performing a specific function by combining the plurality of constituent elements.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method for recognizing a moving object, the method comprising:
receiving real-time video data from an image capturing device by an object recognition apparatus;
extracting a first image at a first time point of the real-time video data by the object recognition apparatus;
extracting a first background image from the first image;
extracting a second image at a second time point of the real-time video data by the object recognition apparatus, wherein the second time point is after the first time point;
updating the first background image to a second background image based on the second image;
comparing the second image with the second background image to extract a moving object; and
extracting the moving object.

2. The method of claim 1, wherein updating the first background image to the second background image further comprising:
setting the first image as a reference image, and
generating a co-registration image based on the reference image.

3. The method of claim 2, further comprising:
separating the co-registration image into an interest region and a surrounding region.

4. The method of claim 2, wherein extracting the moving object comprises:
extracting an object by comparing the co-registration image with the second background image.

5. The method of claim 1, wherein updating the first background image to the second background image comprises:
comparing pixels of corresponding positions between the second background image and the second image;
determining a region changed in the second background image from the second image based on a result of the comparison; and
updating the first background image based on pixel information of the region changed.

6. The method of claim 5, wherein comparing pixels of corresponding positions between the second background image and the second image comprises:
comparing a difference between a pixel pattern of a comparison target pixel and a surrounding pixel of the second background image and a pixel pattern of the comparison target pixel and a surrounding pixel of the second image.

7. The method of claim 6, wherein extracting the moving object comprises:
extracting the moving object based on the difference between the pixel pattern of the comparison target pixel and the surrounding pixel of the second background image and the pixel pattern of the comparison target pixel and the surrounding pixel of the second image.

8. The method of claim 7, wherein extracting the moving object comprises:
separating a region corresponding to the moving object in the second image to extract a resulting image.

9. A method for analyzing an object flow, the method comprising:
analyzing image data received from one or more image capturing devices to extract one or more moving objects from each image data by an object flow analyzing device;
computing a velocity vector of the extracted one or more moving objects by the object flow analyzing device;
clustering the one or more moving objects extracted into one or more clusters based on a direction and a magnitude of the velocity vector by the object flow analyzing device;
selecting a central object among the one or more moving objects for the one or more clusters, respectively, based on the clustering by the object flow analyzing device; and
determining a flow of the one or more clusters to which the central object belongs using a motion of the central object by the object flow analyzing device.

10. The method of claim 9, wherein the clustering comprises:
measuring a cluster density of each of the one or more clusters.

11. The method of claim 10, wherein measuring the cluster density comprises:
computing an average distance between the central object and the one or more moving objects apart from the central object; and
measuring the cluster density based on the average distance.

12. The method of claim 9, wherein determining the flow of the one or more clusters to which the central object belongs comprises:
re-computing velocity vectors of the one or more moving objects belonging to the one or more clusters, and re-clustering the one or more moving objects into two or more clusters based on the direction and the magnitude of the velocity vectors re-computed of the one or more moving objects.

13. The method of claim 9, wherein determining the flow of the cluster to which the central object belongs comprises:
re-computing velocity vectors of the one or more moving objects belonging to the one or more clusters, and re-clustering the one or more moving objects based on the direction and the magnitude of the velocity vectors re-computed of the one or more moving objects to merge the one or more clusters.

14. The method of claim 9, wherein setting the central object comprises:
selecting an arbitrary moving object in a cluster as a first object;
calculating an average distance between the first object and a moving object belonging to the cluster;
determining whether the first object is at a statistical center of the one or more moving objects belonging to the cluster based on the average distance; and
selecting the first object as a central object when the first object is determined to be at the statistical center, and selecting a second object as the first object.

15. The method of claim 9, wherein the flow of the cluster indicates a flow of traffic on a road, and
the method further comprising:
providing real-time traffic information corresponding to the flow of the one or more clusters to a user terminal by the object flow analyzing device.

16. The method of claim 15, wherein providing the real-time traffic information to the user terminal comprises:
analyzing a traffic flow of an interest region;
analyzing the traffic flow in a surrounding region of the interest region; and
correcting the traffic flow of the interest region based on the traffic flow of the surrounding region flowing into the interest region; and
providing a predicted traffic information of the interest region to the user terminal based on the traffic flow corrected.

17. The method of claim 15, wherein providing the real-time traffic information to the user terminal comprises:
recommending a bypass route to a user of the user terminal in real time,
wherein recommending the bypass route comprises:
analyzing the traffic flow of a position in a traveling direction of the user,
analyzing the traffic flow of a surrounding position of the position in the traveling direction,
correcting the traffic flow of the position in the traveling direction based on the traffic flow of the surrounding position flowing into the position in the traveling direction,
generating a bypass route based on the corrected traffic flow, and
recommending the bypass route to the user.

18. A method for analyzing traffic information, the method comprising:
receiving a plurality of image data from a plurality of image capturing devices, respectively,
analyzing the plurality of image data received;
extracting a plurality of moving objects from the plurality of image data analyzed;
computing velocity vectors of the plurality of moving objects extracted;
clustering the plurality of moving objects extracted into clusters based on direction and magnitude of the velocity vectors;
selecting a central object among the plurality of moving objects from the clusters, respectively;
determining flows of the clusters to which the central object belongs using a motion of the central object; and
providing real-time traffic information corresponding to the flows of the clusters to a user terminal.

19. The method of claim 18, wherein the plurality of the image data comprises position information of the plurality of image capturing devices, and
wherein the method further comprises generating a traffic information map based on the position information.

20. The method of claim 18, wherein the method further comprises recommending a bypass route to the user terminal based on the flows of the clusters corresponding to a position in a traveling direction and a surrounding position.
